(19) United States
(12) Patent Application Publication
(10) Pub. No.: US 2026/0331410 A1
(43) Pub. Date: Oct. 22, 2026

(54) Fuse

(71) Applicant: MERSEN France SB SAS, SAINT-BONNET-DE-MURE (FR)

(72) Inventors: Gianfranco DE PALMA, Saint Barthélémy d’Anjou (FR); Jean-Francois OEUVRARD, LYON (FR); Laurent MILLIERE, LYON (FR)

(21) Appl. No.: 19/109,547

(22) PCT Filed: Sep. 8, 2023
(86) PCT No.: PCT/EP2023/074721

§ 371 Date: Mar. 6, 2025

(30) Foreign Application Priority Data
Sep. 9, 2022 (FR) FR2209072

(51) Int. Cl. H01H 85/47; H01H 85/10

(52) U.S. Cl. CPC H01H 85/47; H01H 85/10

(57) ABSTRACT

The fuse (100) comprises a housing with a metal cooling wall (120) which bounds an internal space of the housing. The fuse also comprises a fuse link (130), which is accommodated in the internal space and which comprises a main portion, which portion is made in one piece and which comprises two ends (132A, 132B), between which a first, reduced section (136) is made. The main portion comprises at least one support (142) via which the main portion is attached to the wall (120) so as to hold the reduced section (136) away from the wall (120). The fuse also comprises a spacer (140), which is inserted between each support and the wall, each spacer (140) comprising a central layer (144), which comprises two opposite faces (146A, 146B) electrically insulated from one other, and two connecting layers (152), which are applied to a respective face of the central layer. One of the connecting layers is attached to the wall, while the other connecting layer is attached to each support.

### CROSS-REFERENCE TO RELATED APPLICATIONS

This application claims benefit under 35 USC § 371 of PCT Application No. PCT/EP2023/074721 entitled FUSE, filed on Sep. 8, 2023 by inventors Gianfranco De Palma, Jean-Francois Oeuvrard and Laurent Milliere. PCT Application No. PCT/EP2023/074721 claims priority of French Patent Application No. 22 09072, filed on Sep. 9, 2022.

### FIELD OF THE INVENTION

The present invention relates to a fuse.

### BACKGROUND OF THE INVENTION

A fuse, sometimes also called a “fuse cartridge”, is an electrical component with two terminals that serves, in the event of an overcurrent beyond a limit called a fuse rating, to interrupt the flow of electrical current between the two terminals. The two terminals are attached to an insulating body providing a cavity and are electrically connected to each other by means of at least one fuse link arranged within the cavity of the insulating body. One or a plurality of fuse blades may be connected in parallel to the two terminals depending on the size of the fuse. What is described for a fuse link is transposable to other fuse links when there is a plurality of said fuse links.

A fuse link is made of a conductive material having a given electrical resistance and a given melting temperature. When an electric current flows through the fuse link, the fuse link heats up via the Joule effect. During normal operation, the temperature of the fuse link remains below the melting temperature. In the event of an overcurrent, the temperature of the fuse link increases and exceeds the melting temperature at one or a plurality of points of the fuse link, which melts at least partially, and the current flow is irreversibly cut off. The fuse link includes, between the connections with the two poles, at least one intermediate portion having a reduced surface section. Such an intermediate portion is called a “reduced section”. Each reduced section provides greater resistance to current flow than the rest of the link. As the intensity of the current flowing through the link increases, the temperature of each reduced section increases more than the temperature of the rest of the link. In the event of an overcurrent, the melting of the link preferentially takes place at a reduced section.

When a reduced section melts, an electric arc is created and a current continues to flow until the electric arc is extinguished. The electric arc, defined as a plasma state of the material, causes a strong localized heating which favors the melting of the fuse link. With thermal and electrical conditions, such change of state of the material of the fuse link favors, in turn, the maintenance and the elongation of the electric arc. The cavity is usually filled with an arc extinguishing material, usually sand, in order to reduce the cut-off time of the fuse.

For certain high-power applications, in particular for recharging electric vehicles, the fuses must both have a high rating, in order to reduce the recharging time, while limiting as much as possible a short-circuit leakage current when the fuse blows. One also refers to a PLTC (Peak Let Through Current). The PLTC current is related, among others, to the cut-off time of the fuse. In the case of vehicle charging, in the event of a charging malfunction, the lower the PLTC current, the lower the risk of fire in the vehicle. It is thus necessary to have a fuse that provides the highest possible rated current, to reduce the recharge time, while maintaining the lowest possible PLTC current.

The PLTC current is e.g. limited by certain standards, e.g. the standard ISO17409:2020 relating to the charging of electric vehicles. As an illustration, according to said standard, for a vehicle charging at a voltage of 1000 V, with a rated current of 1000 A, the permissible limit of PLTC is 30 kA. However, such performances are not accessible to fuses with a conventional architecture.

A known approach for improving the performance of fuses consists in cooling the fuse link, so as to remove the heat generated by the Joule effect when the current flows through the fuse link.

WO-2012 025853-A1 describes e.g. a fuse with a housing comprising a cooled wall made of electrically insulating ceramic. The fuse link is formed of multiple elements which are bonded directly to the cooled wall. However, such a fuse is difficult to manufacture, each element of the fuse link being individually attached to the wall. The ceramic wall, which remains relatively thin so as not to hinder the transfer of heat and furthermore relatively fragile, risks breaking, in particular in the event of an impact or under the effect of the temperature differentials between the two faces thereof.

EP0292225A2 describes a fuse with a metal wall on which a ceramic wafer is laminated. A metal circuit is formed directly on an inner face of the wafer, so as to form the fusible element. However, such a structure is not suitable for fusible elements comprising a plurality of reduced sections. On the other hand, when the fuse is filled with sand, the sand is present on only one side of the fusible element. Such a fuse cannot efficiently interrupt with a short cut-off time, overcurrents involving high energy levels, e.g. in the case of vehicle charging.

### SUMMARY OF THE INVENTION

The presents invention intends more particularly to overcome such issues, by proposing a robust, high-performance fuse.

To this end, the invention relates to a fuse, comprising:
a housing, the housing comprising a wall which is made of metal and which delimits an internal volume of the housing, the wall being configured to be cooled from the outside of the housing, and
a fuse link, which comprises:
   a main portion, which is made of one piece, which is received in the internal volume and which comprises two opposite ends, and
   a reduced section, which is provided in the main portion between the two end zones.

According to the invention:
the main portion comprises at least one support, by which the main portion is attached to the wall.
the fuse comprises a spacer, which is inserted between each bracket and the wall, each spacer comprising:
   a central layer, which comprises two opposite faces electrically insulated from each other, and
   two connecting layers, each of which is made of a connecting material and which are applied to a respective side of the central layer, one of the connecting layers being attached to the wall, while the other connecting layer is attached to each support,
each support is arranged so as to maintain the reduced section at a distance from the wall.

By means of the invention, the wall of the housing which serves to cool the fuse during the use thereof is made of metal and is thus resistant to impacts and to thermal cycles. The fuse link is bonded to the metal wall while remaining electrically insulated from the metal wall, while the reduced section is kept at a distance from the metal wall. When the reduced section melts, the electric arc extends on both sides of the fuse link. Advantageously, when the fuse is assembled, the housing is filled with a material that enhances the extinction of electric arcs, e.g. sand. The sand is found on both sides of the reduced section, contributing to the good extinction of the arc in case of melting of the reduced section.

According to advantageous but non-mandatory aspects of the invention, such a fuse can incorporate one or a plurality of the following features, taken individually or according to any technically permissible combination:
The main portion comprises two reduced sections, while the main portion provides an intermediate support, which is arranged between the two reduced sections and which is attached to the wall by means of a spacer, and the fuse link is formed so as to keep the reduced sections associated with the intermediate support at a distance from the wall.
The fuse link comprises at least one support which is provided such that the support is located outside the conduction path of the fuse link when a current flows through the fuse link.
At least one of the end supports and the intermediate support comprises at least one support lug, each support lug being formed by cutting out the fuse link and having an elongate shape with a first end, which is connected to the fuse link, and a second end, which is opposite the first end and which is attached to the wall by the corresponding spacer.
In the case of at least one support tab, the support tab is cut out in the vicinity of a reduced section, the cut-out of the support tab forming a perforation for the reduced section.
The support is formed by folding a folding zone of the main portion, the folding zone extending over a length of the main portion and comprising two end zones and an intermediate zone located between the two end zones, while the intermediate zone is folded to form the support, and the two end zones are in electrical contact with each other.
For at least one of the reduced sections of the main portion, the main portion comprises two supports associated with the reduced section, while an insulating element is inserted between the reduced section and the wall, and the insulating element at least partially closes a gap between the two intermediate supports associated with the reduced section.
For at least one of the reduced sections of the main portion, the main portion comprises two adjacent supports associated with the reduced section, whereas for the two spacers associated with the two supports, the central layer of the two spacers is made in one piece, so as to close a gap between the two supports.
The central layer is made of an electrically insulating polymer material.
The central layer is made of ceramic.
Studs are inserted between each spacer and the fuse link so as to increase a distance between each reduced section and the wall.
The wall comprises protrusions, which are provided on the surface of the wall and which are arranged opposite each spacer, so as to increase a distance between each reduced section and the wall.
The housing comprises, in addition to the wall, a supplementary portion of the wall:
   the supplementary portion is made of an insulating material and delimits, with the wall, the internal volume of the housing,
   for at least one of the reduced sections, the supplementary portion of the housing comprises at least two protrusions, which extend within the internal volume and which are arranged on both sides of the reduced section, so as to limit the propagation of electric arcs in the internal volume when the reduced section melts.

### BRIEF DESCRIPTION OF THE DRAWINGS

The invention will be better understood and other advantages thereof will appear more clearly in the light of the following description of a plurality of embodiments of a fuse according to the principle thereof, given only as an example and made with reference to the enclosed drawings, wherein:

FIG. 1 is a perspective view of an longitudinal section of a fuse according to a first embodiment of the invention;

FIG. 2 shows, on two inserts a) and b) respectively, a perspective view of a section, along a longitudinal plane II in FIG. 1, of a sub-assembly of the fuse of FIG. 1, and a detail of the sub-assembly;

FIG. 3 schematically represents, on four inserts a) to d), a front view of the subassembly of FIG. 2 and a front view of three sub-assemblies each belonging to a fuse according to other embodiments of the invention;

FIG. 4 schematically represents, on four inserts a) to d), a front view of four sub-assemblies each belonging to a fuse according to other embodiments of the invention;

FIG. 5 represents, on two inserts a) and b), two steps of manufacturing of a fuse link belonging to a fuse according to another embodiment of the invention;

FIG. 6 shows, on two inserts a) and b), details of two fuse links belonging each to a fuse according to other embodiments of the invention; FIG. 7 schematically represents, on two inserts a) and b), a detail of a fuse link and a sub-assembly belonging each to the fuse link according to other embodiments of the invention;

FIG. 8 shows, on two inserts a) and b), respectively, two fuses according to other embodiments of the invention, and

FIG. 9 is a section of a fuse according to a second embodiment of the invention.

### DETAILED DESCRIPTION OF EMBODIMENTS

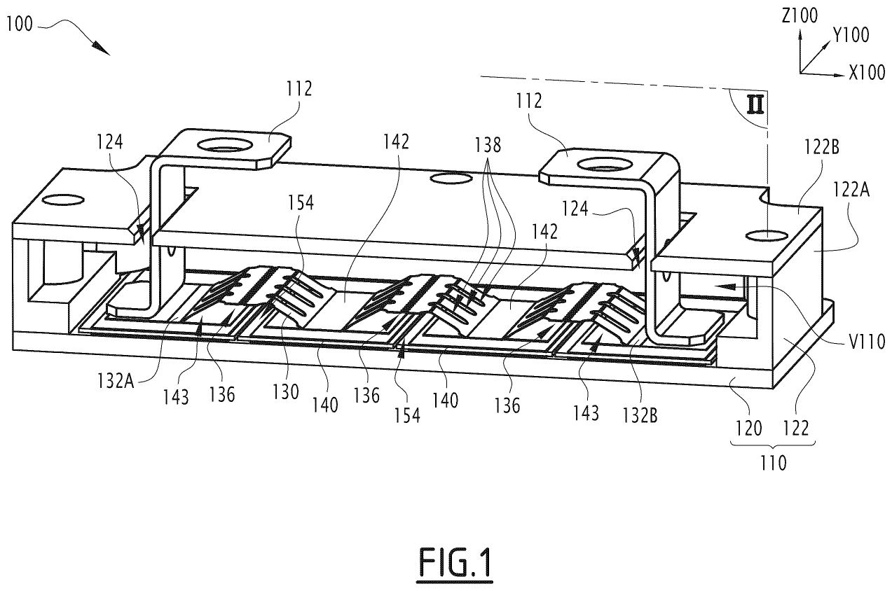

A fuse 100, according to a first embodiment of the invention, is shown in FIG. 1. The fuse 100 comprises a housing 110 and two connection terminals 112.

The housing 110 has generally the form of an elongate cylinder defining a longitudinal axis X100 of the fuse 100. By extension, the reference X100 also refers to a longitudinal direction, which is oriented from the left to the right on the figures.

In the example illustrated, the housing 110 has an overall parallelepipedal shape, i.e. the housing 110 has the shape of a cylinder of rectangular cross-section. The housing 110 is hollow, i.e. the housing 110 delimits an internal volume V110. In the following description, the notions of “top”, “bottom”, etc., are given with reference to the orientation of the various elements of fuse 100 on the drawings, knowing that fuse 100 may be oriented differently in reality.

The housing 110 comprises a wall 120, which is configured to be cooled through the outside of the housing. In normal use of the fuse 100, the wall 120 is attached against a cooling device, e.g. a metal support comprising channels of refrigerated fluid. The cooling device is not shown.

The wall 120 is herein a lower wall of the housing 110. The wall 120 is made of a material having good thermal conductivity, while being resistant to the stresses of use of the fuse 100, in particular to impacts. The wall 120 is herein made of metal, preferably copper or one of the copper alloys. The wall 120 is herein made in a wafer and extends parallel to the longitudinal axis X100 and orthogonally to a height axis Z100 of the fuse.

By extension, the reference Z100 also refers to a height direction, which is oriented from the bottom to the top of the figures. A transverse axis Y100 is also defined as an axis orthogonal to both the longitudinal axis X100 and the height axis Z100, the three axes X100, Y100 and Z100 being arranged to form a direct reference frame.

In addition to the wall 120, the housing 110 also comprises a supplementary portion 122, which cooperates with the wall 120, in particular by matching of shapes, to delimit the internal volume V110. The supplementary portion 122 is made of an electrically insulating material, e.g. of a synthetic polymer such as polyamide, and is manufactured, e.g., by hot injection. The two connection terminals 112 are accessible from outside the housing 120, herein outside the supplementary portion 122.

In the example illustrated, the supplementary portion 122 is made in two parts, with a peripheral portion 122A, which forms a rectangular frame, and a cover 122B, which closes the peripheral portion 122A. The shape of the supplementary portion 122 is not limiting. According to examples, the supplementary portion 122 is concave, whereas the wall 120, provided in a wafer to simplify production, closes the supplementary portion 122, delimiting the internal volume V110 of the housing 110.

In the example illustrated, the terminals 112 stick out of the housing 110 extending through the cover 122B. Such arrangement of the connection terminals 112 is not limiting. The cover 122B comprises openings 124, herein in the form of slots arranged parallel to the transverse axis Y100, through which the terminals 112 pass. Under normal operation of the fuse 100, the internal volume V110 is generally filled with sand. The sand is not shown. The openings 124 are then closed off to prevent sand leaks, e.g. by means of a mastic, in particular a polysiloxane mastic, also called silicone.

The fuse 100 further comprises a fuse link 130, which is received in the internal volume V110. The fuse link 130 is attached to the wall 120 to be cooled during the use of the fuse 100.

The fuse link 130 is made of a conductive material, which has a given electrical resistance and a given melting temperature. The material of the fuse link 130 is preferentially metallic and has a thickness generally comprised between 0.03 mm and 1.0 mm, preferably comprised between 0.06 mm and 0.3 mm. The fuse link 130 is e.g. made of silver, or of copper, or of aluminum, or of tin, or one of the respective alloys thereof. The fuse link 130 is provided herein by perforation and/or cutting out and/or bending a strip of metal, which has a constant width, measured parallel to the transverse axis Y100. Alternatively, the fuse link 130 has a variable width. The long sides of the metal strip are arranged parallel to the longitudinal axis X100 and form longitudinal edges of the fuse link 130.

The fuse link 130 thereby has an elongate shape, which extends substantially along the longitudinal axis X100 and comprises two opposite ends 132A and 132B, each end 132A and 132B herein being attached to the wall 120 and forming a support for the ends 132A and 132B of the fuse link 130. By extension, the references 132A and 132B also refer to the end supports 132A and 132B. Each of the end supports 132A and 132B is herein electrically connected to a respective connection terminal 112. In the example illustrated, each end support 132A and 132B is attached to the wall 120 by means of a respective spacer 140. The spacers 140 are described in detail thereafter.

The fuse link 130 further comprises a main portion 134 which is inserted between the two end supports 132A and 132B. The main portion 134 is herein made of only one piece. The main portion 134 herein comprises three reduced sections 136, the number three not being limiting. In a variant (not shown), the main portion 134 comprises only one reduced section, or two reduced sections, or even four or a plurality of reduced sections.

Each reduced section 136 is formed by a row of holes, the row being oriented along the transverse axis Y100. Thereby, the fuse link 130 has, at each reduced section 136, an electrical resistance greater than the electrical resistance elsewhere than at the reduced sections 136. When an electric current flows between the terminals 112, the fuse link 130 exhibits localized heating at the reduced sections 136. In the event of an overcurrent, the melting of the material of the fuse link 130 preferentially occurs at the reduced sections 136.

In the example shown, the fuse link 130 comprises three identical reduced sections 136. Therefore, the fuse link 130 has a response curve “cut-off time/cut-off current” with a given appearance. In a variant (not shown), the fuse link 130 has a plurality of types of reduced sections, the holes forming each reduced section having e.g. different diameters depending on the reduced section considered. Thereby, when an overcurrent occurs, certain reduced sections 136 are likely to melt faster than others. By combining different types of reduced sections 46, a response curve is obtained which is the superposition of each of the response curves corresponding to each of the reduced sections. Such aspect is not further discussed in detail in the present description.

In the example illustrated, the fuse link 130 also comprises perforations 138, each of which is oblong in shape and which are arranged in rows 139, on both sides of each reduced section 136. Each row 139 herein comprises three perforations 138. The fuse link 130 herein comprises six rows 139 of perforations, which are associated in pairs with each of the reduced sections 136. The perforations 138, or “blowholes”, reduce the amount of material to melt during the progression of the electric arc, when the fuse melts. The progression of the arc is thereby faster than in the absence of blowholes 138, which ultimately reduces the arc extinction time. The operation of the blowholes 138 is not discussed in further detail.

Between two consecutive reduced sections 136, the fuse link 130 advantageously forms an intermediate support 142. The fuse link 130 herein comprises two intermediate supports 142. In the first embodiment, each intermediate support 142 is formed by folding the fuse link 130. Each intermediate support 142 is attached to the wall 120 by means of a spacer 140.

The end supports 132A and 132B, as well as the intermediate supports 142, are thereby attached to the wall 120, the fuse link 130 being formed so as to keep the reduced sections 136 at a distance from the wall 120. The fuse link 130 on the one hand, and the wall 120 and the spacers 140 on the other hand, delimit therebetween cavities 143 which are arranged between each reduced section 136 and the wall 120. The cavities 143 are thus portions of the internal volume V110.

During the use of the fuse 100, when one of the reduced sections 136 melts, the electric arc extends on both sides of the fuse link 130, which enhances the progression, thereof and hence the extinguishing thereof. When the fuse 100 is assembled, the internal volume V110 of the housing 110 is filled with sand. Each of the cavities 143 is also filled with sand. The sand is found on both sides of the fuse link 130 at each reduced section 136, contributing to the good extinction of the arc in the event of melting of one of the reduced sections 136.

In a variant (not shown), arc shields are advantageously attached to the fuse link 130 so as to close, totally or partially, the blowholes 138, and thereby reduce the extinguishing time of the electric arc. The arcs are e.g. silicone tongues, which are bonded to the fuse link 130. The operation of the blowholes 138 and the arcs guards is not discussed in further detail.

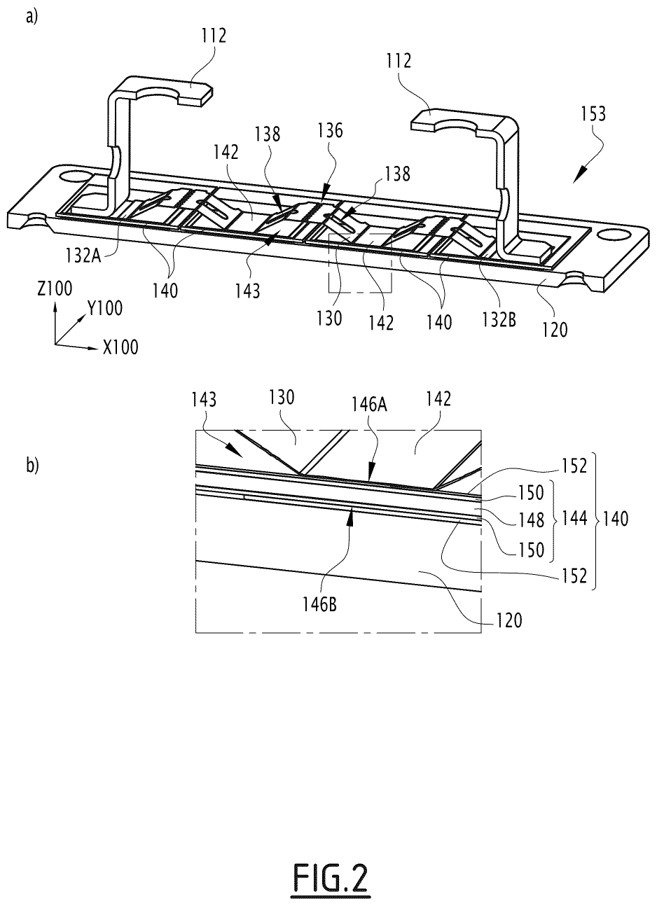

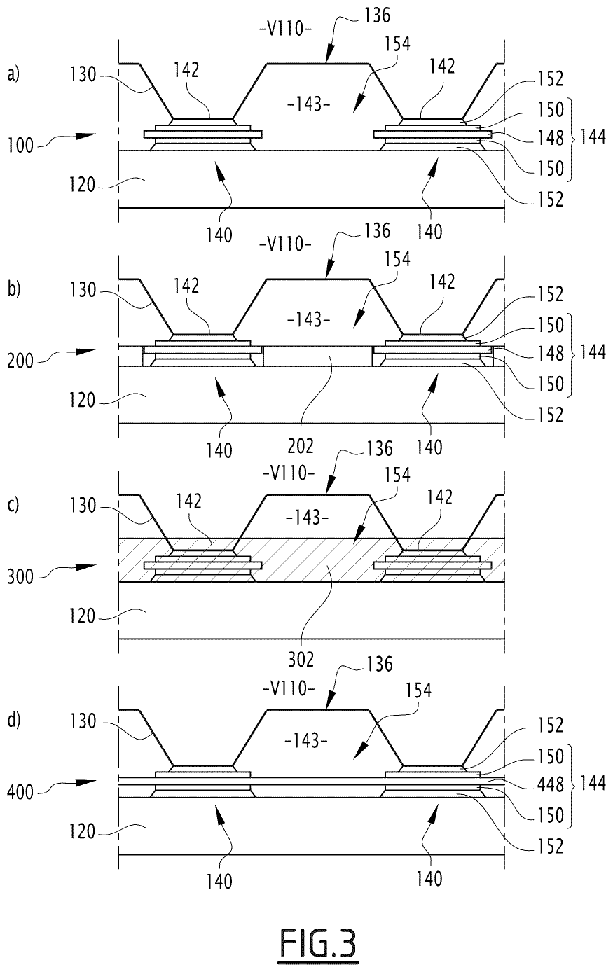

The structure of the spacers 140 will now be described in detail using FIG. 2 and insert a) of FIG. 3. In FIG. 3, the fuse 100 is represented schematically, the dimensional scales not being followed.

In the first embodiment, each of the intermediate supports 142 and the end supports 132A and 132B is attached to the wall 120 by a respective spacer 140. The spacers 140 are herein distinct from one another and are electrically insulated from one another. What is valid for one of the spacers 140 can be transposed to the other spacers 140.

Each spacer 140 has herein the shape of a flattened rectangle, which extends along the length thereof parallel to the transverse axis Y100. Each spacer 140 thereby has a length, measured parallel to the transverse axis Y100, greater than or equal to a width of the fuse link 130. Each spacer 140 also has a width, length, measured parallel to the longitudinal axis X100, greater than or equal to a width of the corresponding intermediate support 142 or of the corresponding end supports 132A and 132B, the width being measured parallel to the longitudinal axis X100. Mechanical strength and heat transfer are thereby ensured throughout the surfaces of each of the intermediate supports 142 or of the end supports 132A and 132B.

Each spacer 140 comprises a central layer 144, which has a flattened shape with two opposite faces. The two opposite faces include a top face 146A, which is oriented toward the internal volume V110, and a bottom face 146B, which is oriented toward the wall 120. The top 146A and bottom 146B faces are electrically insulated from each other. In the first embodiment, the central layer 144 comprises a wafer 148, which is made of ceramic, and which is covered, on each of the faces thereof, with a layer of metal 150, herein copper. The wafer 148 typically has a thickness comprised between 0.2 mm and 1.0 mm. The wafer 148 is herein made of alumina—Al₂O₃—. According to non-limiting alternatives, the wafer 148 is made of aluminum nitride—AlN—or silicon nitride—Si₃N₄—, such materials providing a good compromise between electrical insulation, thermal conductivity and cost.

The wafer 148 and the metal layers 150 are joined together, so as to metallize the faces of the wafer 148. Thereof is referred to as a “metallized ceramic substrate”. The two metal layers 150, separated by the ceramic wafer 148, are electrically insulated from each other.

Among the preferred methods of metallization of ceramic substrates, direct bonding is known, which is a method of temperature pressure welding, without the addition of another interface material between the ceramic substrate and the metal layers. When the metal layers are made of copper, we speak of the DBC (Direct Bonded Copper) method. When the metal layers are made of aluminum, we speak of the DBA (Direct Bonded Aluminum) method.

Bonding by adding a thin layer of brazing material between the ceramic substrate and the metal layers is also known. Such a method is known e.g. by the name of AMB (Active Metal Brazing).

The central layer 144 is herein manufactured by hot pressing of the different elements of which same is composed, according to the direct bonding method DBC.

Once the wafer 148 has been metallized using the metal layers 150, the exposed faces of the metal layers 150 are advantageously covered with a finishing layer, which has a thickness of a few microns and which consists of a metal of a different nature from the nature of the metal layers 150. The finishing layers are not shown. The metal of the finishing layers is chosen according to the application, in particular due to considerations relating to protection against oxidation, to intermetallics, etc. According to non-limiting examples, the finishing layers are made of gold—Au—, or nickel—Ni—, or silver—AG—.

In practice, the thicknesses of the wafer 148 and of the metal layers 150 are chosen according to the thermal, mechanical and electrical stresses encountered by the fuse 100 during the use thereof. A wafer 148 that is too thin may not be sufficiently electrically insulating or mechanically resistant, while a wafer that is too thick may be too thermally insulating. Typically, the wafer 148 has a thickness comprised between 0.1 mm and 1.0 mm.

Similarly, an excessively thin metal layer 150 does not allow good adhesion to the wafer 148 following the metallization method, herein the DBC method. Typically, each metal face layer 150 has a thickness comprised between 0.2 mm and 0.4 mm.

In the example illustrated, the wafer 148 has a thickness equal to 0.6 mm, whereas each of the metal layers 150 has a thickness equal to 0.3 mm. In other words, the central layer 144 has herein a thickness equal to 1.2 mm.

Each spacer 140 further comprises two connecting layers 152. The central layer 144 is interposed between the two connecting layers 152. In the first embodiment, each of the connecting layers 152 is produced by means of a brazing flux.

Schematically, during the assembly of the fuse 100, each spacer 140 is positioned on the wall 120, while the fuse link 130 is positioned on the spacers 140. The assembly is then heated, e.g. in a furnace, so as to melt the brazing flux. When the brazing flux cools, same solidifies and forms each of the connecting layers 152, ensuring the mechanical strength of the fuse link 130 to the wall 120, while ensuring the electrical insulation between the fuse link 130 and the wall 120. One of the connecting layers 152 is attached to the wall 120, whereas the other connecting layer is attached to the main portion 134. Typically, the connecting layer 152 has a porosity comprised between 20 μm and 200 μm. In the example illustrated, each connecting layer 152 has a thickness substantially equal to 100 μm. The order of the steps described hereinabove is not limiting.

Once assembled to each other, the wall 120, the fuse link 130 and the spacers 140 together form a sub-assembly 153 for mounting the fuse 100.

Preferably, the metal layer 150 situated on the top side 146A has a surface area as small as possible, e.g. a surface area substantially equal to a surface area of the opposite end support 132A or 132 B or of the intermediate support 142, so as to provide good mechanical support while reducing the risks of flashes. On the other hand, the metal layer 150 situated on the bottom side 146B has the widest possible surface, so as to provide good heat transfer between the wafer 148 and the wall 120.

Preferably, for each spacer 140, the metal layers 150 only partially cover the corresponding wafer 140, so as to reduce the risk of flashes between two adjacent spacers 140. In the illustration of FIG. 3a), there remains a gap 154 between the two spacers 140 shown. The gap 154 is thus situated between the wafer 120 and the opposite reduced section 136. The internal volume V110 is normally filled with sand.

The other embodiments of the invention will now be described. In the other embodiments, the elements analog to the elements of the first embodiment have the same references and work in the same way. The differences between each embodiment and the preceding embodiment or embodiments is described hereinafter.

A fuse 200, according to another embodiment of the invention, is shown in insert b) of FIG. 3. One of the main differences between said embodiment and the preceding embodiment is that the gap 154 is closed off by an insulating element 202. The insulating element 202 is made of an electrically insulating material, e.g. silicone. In other words, the insulating element 202 is inserted between the reduced section 136 and the wall 120 and closes off the gap 154 between the two intermediate supports 142 associated with the reduced section. Thereby, when the opposite reduced section 136 melts, the insulating element 202 prevents the formation of an electric arc between the fuse link 130 and the wall 120. The insulating element 202 is herein bonded directly to the wall 120, using an adhesive. The adhesive is not shown.

A fuse 300, according to another embodiment of the invention, is shown in the insert c) of FIG. 3. One of the main differences between said embodiment and the preceding embodiments is that the fuse 300 comprises an insulating element 302 which forms a continuous layer on the surface of the wall 120. The insulating element 302 is represented by a hatched zone in FIG. 3 c). The insulating coating 302 is made of an electrically insulating material, e.g. an epoxy resin, or a silicone gel, or equivalent, which is applied after the assembly of the fuse link 130, the spacers 140 and the wall 120. The insulating coating 302 covers herein, on the side of the internal volume V110, all the intermediate supports 142, the associated spacers 140, and the gaps 154 between two successive spacers 140. In other words, for each reduced section 136, the insulating element 302 is inserted between the reduced section 136 and the wall 120 and closes off the gap 154 between the two intermediate supports 142 associated with the reduced section. Advantageously, the insulating coating 302 also covers the end supports 132A and 132B.

A fuse 400, according to another embodiment of the invention, is shown in the insert d) of FIG. 3. One of the main differences between said embodiment and the preceding embodiments is that each spacer 140 comprises a ceramic wafer 448 which extends continuously between two successive spacers 140 so as to close off the gap 154 between the two corresponding intermediate supports 142. In FIG. 3 d), the central layer 144 of the two adjacent spacers 140 is made in one piece, so as to close off the gap 154 between the two intermediate supports 142 associated with the spacers 140. Advantageously, the wafer 448 is common to all the spacers 140 attached to the wall 120, so as to electrically insulate the assembly of the fuse link 130 from the wall 120.

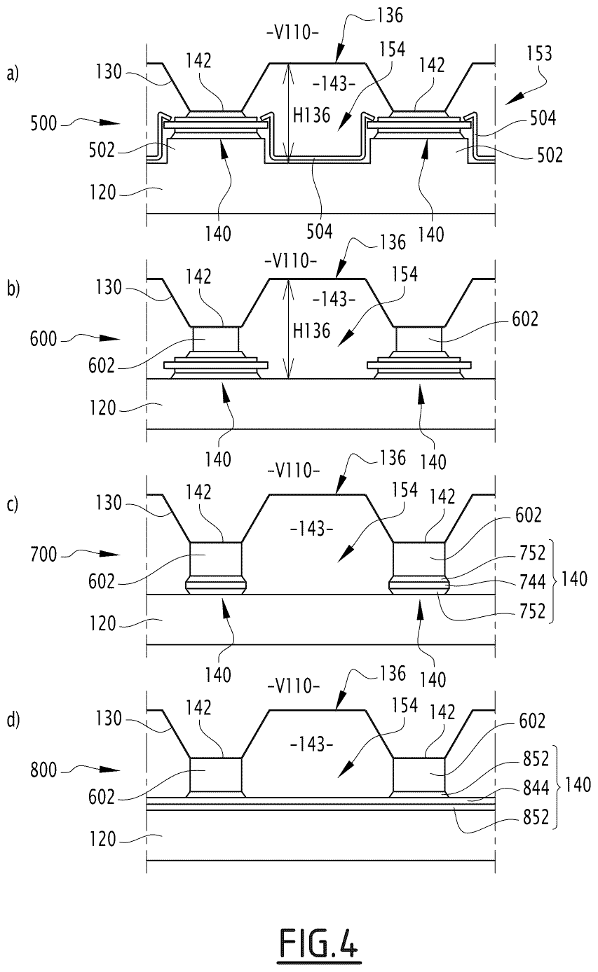

A fuse 500, according to a second embodiment of the invention, is represented in the insert a) in FIG. 4. One of the main differences between said embodiment and the preceding embodiments is that the wall 120 of the fuse 500 comprises, on the side of the internal volume V110, protrusions 502, which are formed on the surface of the wall 120 and which are arranged opposite each spacer 140. The protrusions 502 are formed e.g. by machining the wall 120.

Each spacer 140 is thereby raised with respect to the rest of the wall 120. A height H136, measured parallel to the height axis Z100, between each reduced section 136 and the wall 120, is thereby increased with respect to the preceding embodiments, which reduces the risk of an electric arc passing between one of the reduced sections 136 and the wall 120.

Preferably, insulating elements 504 are arranged between two successive protrusions 502, so as to prevent the transmission of an electric arc between the fuse link and the wall 120 at the insulating elements 504. In the example illustrated, the insulating elements 504 are made of an electrically insulating elastomer material, e.g. silicone. The insulating elements 504 are assembled e.g. by clipping or bonding to the mounting subassembly 153.

A fuse 600, according to another embodiment of the invention, is shown in insert b) of FIG. 4. One of the main differences between said embodiment and the preceding embodiments is that studs 602 are inserted, during the manufacture of the mounting subassembly 153, between each spacer 140 and the fuse link 130, so as to increase the height H136. The studs 602 are herein made of a thermally conductive material compatible with the assembly by brazing. The studs 602 are preferably made of metal, else preferably made of copper or one of the copper alloys.

A fuse 700, according to another embodiment of the invention, is shown in the insert c) of FIG. 4. One of the main differences between said embodiment and the preceding embodiment is that each spacer 140 comprises a central layer 744 made of an electrically insulating polymer material. In a non-limiting manner, examples of such a material are polyethylene terephthalate (also called PET), polybutylene terephthalate (also called PBT), polyimide (also called PI), e.g. distributed in the form of a film under the trade name “Kapton”, meta-aramid, e.g. distributed in the form of a film under the trade name “Nomex”, polyetheretherketone (also called PEEK).

In general, the surface thermal resistance “R” of a material, expressed in m²·K/W—square meter Kelvin per Watt—is equal to the thickness “e” of the material, expressed in meters and measured along the direction of heat transfer, divided by the thermal conductivity λ of the material, expressed in W/m·K—Watt per meter Kelvin—. In other words, R=e/λ.

Although the thermal conductivity λ of the material of the central layer 744, made of polymer material, is less than the thermal conductivity λ of the material of the wafer 148 of the preceding embodiments, made of ceramic, the thickness e of the central layer 744 of polymer material is much less than the thickness of the ceramic wafer 148. It results therefrom that the surface thermal resistance R of the central layer 744 stays at an acceptable level, comparable to the surface thermal resistance R of the layer 148.

As illustrations, the thickness of the central layer 744 made of polymer material is generally comprised between 25 μm and 250 μm, whereas the wafer 148 has herein a thickness of 0.6 mm. When the central layer 744 is made of polyimide, the thermal conductivity λ is typically comprised between 0.46 W/m·K and 0.75 W/m·K, to be compared with the dielectric strength of 200 kV/mm. In other words, a polyimide film with a thickness of 50 μm has a surface thermal resistance R ranging from 66 mm²K/W to 110 mm²K/W, for a breakdown voltage of 10 kV, which is sufficient for an application using voltages on the order of 1 kV. In comparison, when the wafer 148 is made of alumina, the thermal conductivity λ is typically comprised between 14 and 28 W/m·K, to be compared with a dielectric strength of 35 kV/mm. Thereby, an alumina wafer 148 with a thickness of 1 mm has a surface thermal resistance R ranging from 35 mm²K/W to 71 mm²K/W for a breakdown voltage of 35 kV.

The central layer 744 is thereby in the form of a polymer film, which is less likely to break than the wafer 148 of the preceding embodiments. Optionally, the central layer 744 integrates a fibrous reinforcement so that the central layer 744 forms a layer of composite material. The fibers are preferably made of an electrically insulating material, e.g. glass fibers.

The central layer 744 is interposed between two connecting layers 752. In the embodiment of FIG. 4 c), each of the connecting layers 752 is made using a layer of adhesive material. Each of the connecting layers 752 has a porosity comprised between 25 μm and 100 μm.

The material of the connecting layers 752 is chosen according to the performance of temperature resistance, durability, processing time, etc. Non-limiting examples of adhesives used to form the connecting layers are silicone adhesives, acrylic adhesives, polyurethane adhesives, epoxy adhesives, cyanoacrylate adhesives, etc.

A fuse 800, according to another embodiment of the invention, is shown in the insert d) of FIG. 4. One of the main differences between said embodiment and the preceding embodiment is that the spacer 140 comprises a central layer 844, herein made of a polymer film, which extends continuously between two successive intermediate supports 142, so as to electrically separate the fuse link 130 from the wall 120. In other words, the central layer 844 covers at least one gap 154 between two consecutive intermediate supports 142. Advantageously, the central layer covers the wall 120 at least over a surface corresponding to a projection of the fuse link 130 onto the wall 120 along the height axis Z100.

The central layer 844 is interposed between two connecting layers 852. Preferably, the connecting layer 852 situated between the central layer 844 and the wall 120 covers the central layer 844 over the entire surface of the central layer 844, so as to maximize the mechanical strength and the heat transfer between the spacer 140 and the wall 120.

Preferably, the connecting layer 852 situated between the central layer 844 and the fuse link 130 wall 120 covers the central layer 844 over the entire surface of the central layer 844, so as to facilitate the attachment of the fuse link 130 to the spacer 140.

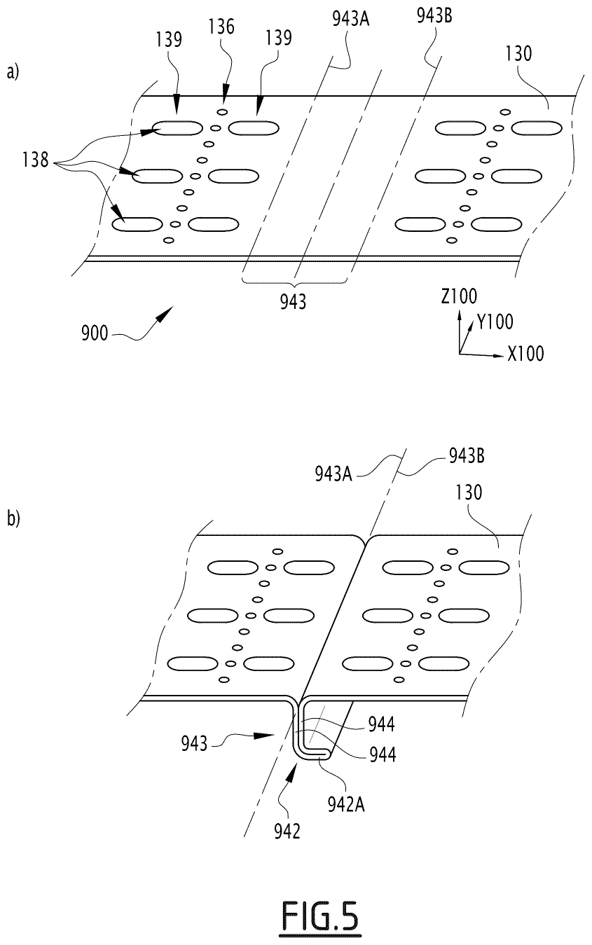

In all the embodiments described so far, when an electric current flows in the fuse link 130, the current also flows through the intermediate supports 142. In the embodiments illustrated in FIGS. 5 to 8, the fuse link 130 is arranged so as to prevent the passage of current through the intermediate supports. Such embodiments are presented hereinafter.

A fuse 900, according to a second embodiment of the invention, is shown in FIG. 5. One of the main differences between said embodiment and the preceding embodiments is that the fuse link 130 comprises an intermediate support 942 formed by folding a folding zone of the fuse link 130 onto itself.

In insert a) of FIG. 5, the fuse link 130 is shown during an intermediate step, during the manufacture of the fuse link 130.

The fuse link has, between two successive reduced sections 136, a folding zone 943. The folding zone 943 is herein a continuous zone, which is delimited by two boundaries, or end zones 943A and 943B. The two end zones 943A and 943B are represented herein by chain-dotted lines, which are parallel to the transverse axis Y100. During the folding of the folding zone 943, the two end zones 943A and 943B are brought closer to each other, the folding zone 943 being folded back on itself, forming the intermediate support 942. In the example illustrated, one end 942A of the intermediate support 942 is bent so that the intermediate support 942 has an “L” shape, one foot of the L being configured to be attached to the wall 120 by means of a spacer, as defined hereinabove. The spacer is not shown in FIG. 5.

The intermediate support 942, obtained by folding the folding zone 943 onto itself, thereby comprises two walls 944. The two walls 944 are preferably secured to each other so as to provide an electrical contact between the two walls. According to examples, the two walls 944 are secured to each other by welding, in particular by laser welding, or by brazing, by means of a brazing flux.

As a result, the two end zones 943A and 943B are in electrical contact with each other at the same electrical potential. When a current flows through the fuse link 130, the current does not flow through the intermediate support 942. In other words, the intermediate support 942 is situated outside the conduction path of the fuse link 130. In the event of melting of one of the reduced sections 136, the risks of an electric arc moving towards the end 942A of the intermediate support 942 are reduced.

On the other hand, the intermediate support 942, formed by two walls 944 secured to each other, is advantageous. Same is both mechanically resistant and enhances the transfer of the heat generated at the reduced sections 136 to the end 942A thereof.

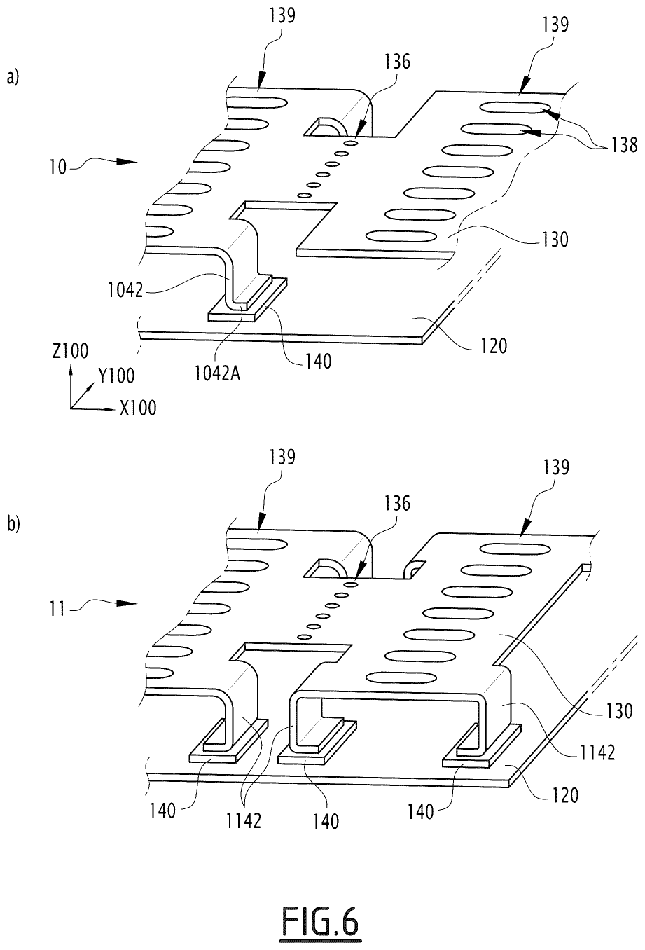

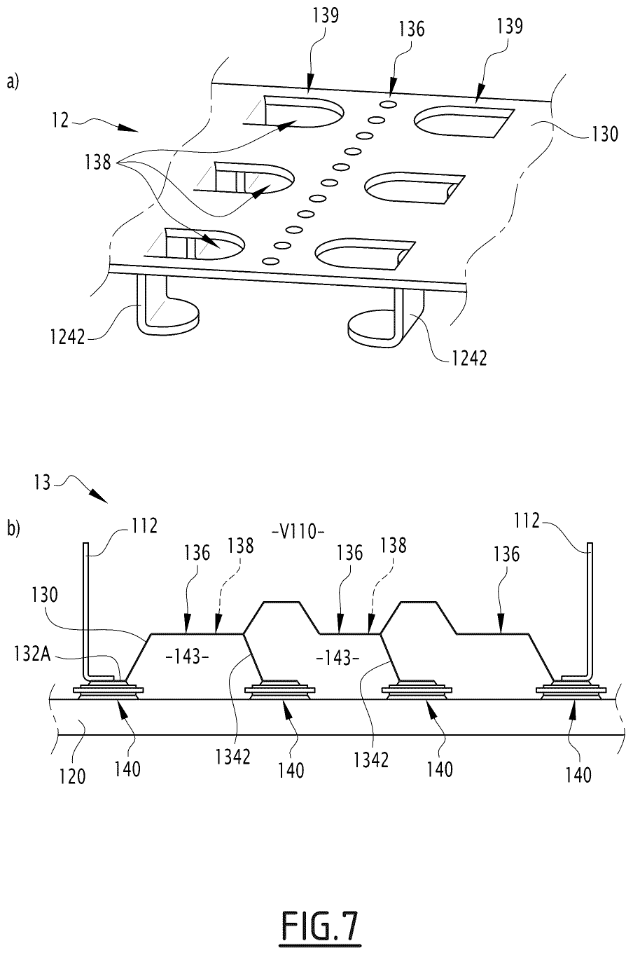

A fuse 10, according to a second embodiment of the invention, is represented in the insert a) in FIG. 6. One of the main differences between said embodiment and the preceding embodiments is that the fuse link 130 comprises intermediate supports 1042 which are formed by cutting out of the fuse link 130. The intermediate supports 1042 are provided herein along the longitudinal edges of the fuse link 130, i.e. a cut-out profile of the intermediate supports 1042 is secant to one of the longitudinal edges of the fuse link 130.

In the example illustrated, the intermediate supports 1042 are support lugs, which are formed on both sides of a reduced section along the transverse direction Y100. Each support lug has an elongate shape with a first end, which is connected to the fuse link 130, and a second end 1042A, which is opposite the first end. Each support lug thereby remains attached, by a bridge of material, to the rest of the fuse link 130. Once cut out, each support tab is folded into the desired shape, so as to form the corresponding intermediate support 1042, the second end 1042A being configured to be attached to the wall 120 by means of a respective spacer 140, so as to keep the reduced sections 136 at a distance from the wall 120. The shape and the layout of the intermediate supports 1042 are not limiting.

Providing the intermediate supports 1042 on both sides of a reduced section 136 correspondingly reduces the quantity of material to be melted when the reduced section 136 is melted. On the other hand, being situated in the immediate vicinity of the reduced section 136, the intermediate supports 1042 contribute to the good transfer of heat toward the wall 120. Finally, each of the intermediate supports 1042 is situated outside the conduction path of the fuse link 130, i.e. no current flows through the intermediate supports 1042 when a current flows through the fuse link 130.

A fuse 11, according to another embodiment of the invention, is shown in insert b) of FIG. 6. As in the preceding embodiment, the fuse link 130 provides intermediate supports 1142 which are formed by cutting out and bending the fuse link 130. One of the main differences between said embodiment and the preceding embodiment is that the fuse link 130 comprises intermediate supports 1142 which are arranged in pairs in the fuse link 130. The two intermediate supports 1142 of the same pair are thereby provided opposite each other along the longitudinal direction X100. Advantageously, the intermediate supports 1142 of the same pair are formed on either side, along the longitudinal axis X100, of a reduced section 136, so as to increase the transfer of heat between the reduced section and the wall 120.

A fuse 12, according to a second embodiment of the invention, is represented in the insert a) in FIG. 7. The fuse link 130 comprises intermediate supports 1242 which are formed by cutting out and folding the fuse link 130. One of the main differences between said embodiment and the two preceding embodiments is that the intermediate supports 1242 are arranged at a distance from the longitudinal edges of the fuse link 130. In other words, the cut-out profile of each intermediate support 1242 is not secant with one of the longitudinal edges of the fuse link 130.

In the example illustrated, each intermediate support 1242 is obtained by cutting out and then folding the fuse link 130 in the vicinity of one of the reduced sections 136. Once the intermediate support 1242 has been formed, the cut-out of the intermediate support 1242 leaves in the fuse link 130 an opening which forms one of the blowholes 138 associated with the reduced section 136. The material cut out to form the blowholes 138 is advantageously used to form the intermediate supports 1242. Stated otherwise, a blowhole 138 is formed jointly with each intermediate support 1242 by folding and cutting out the fuse link 130. Of course, if need be, other blowholes are provided in the fuse link 130.

Each of the intermediate supports 1242 is situated outside the conduction path of the fuse link 130, i.e. that no current flows through the intermediate supports 1242 when a current flows through the fuse link 130.

A fuse 13, according to another embodiment of the invention, is shown in insert b) of FIG. 7. The fuse link 130 comprises intermediate supports 1342 obtained in the same way as the intermediate supports 1242 of the preceding embodiment, i.e. by cutting out and folding the fuse link 130, so as to jointly form the intermediate supports 1342 and the associated blowholes 138.

The intermediate supports 1342 and the end supports 132A and 132B are herein attached to the wall 120 by means of spacers 140 similar to same of the first embodiment, i.e. comprising the central layer 144 integrating the wafer 148 of ceramic metallized by a DBC method.

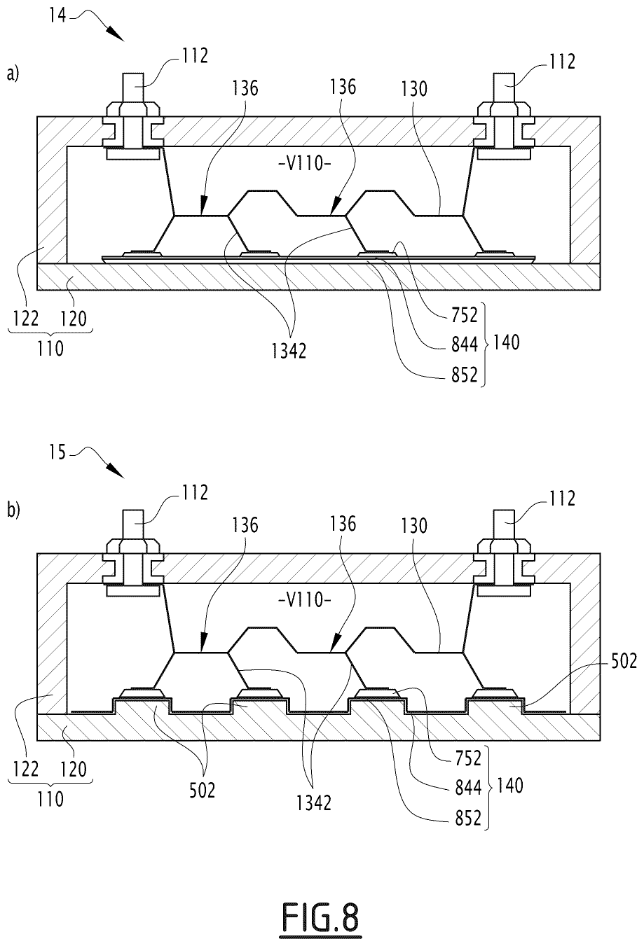

A fuse 14, according to a second embodiment of the invention, is represented in insert a) in FIG. 8. One of the main differences between said embodiment and the preceding embodiment is that the spacer 140 comprises a central layer of the same type as the central layer 844 of the embodiment shown in FIG. 4 d), i.e. that the central layer 844 is a film made of an electrically insulating polymer material which extends continuously between the intermediate supports 1342. Preferably, the central layer 844 extends over the surface of the wall 120 at least over the entire projection, along the height axis Z100, of the fuse link 130 onto the wall 120.

The end supports 132A and 132B of the fuse link 130 are herein connected directly to the connection terminals 112, without being attached to the wall 120, whereas intermediate supports 142 are provided between each of the ends 132A or 132B and the reduced portions 136 adjacent to the ends.

The connecting layer 852 between the central layer 844 and the wall 120 is also continuous, in order to provide good mechanical resistance and good heat transfer between the central layer 844 and the wall 120. For each of the intermediate supports 1342, the connecting layer 752 between the central layer 844 and the corresponding intermediate support 1342 is herein limited to the surface area sufficient to ensure good attachment between the intermediate support 1342 and the central layer 844.

A fuse 15, according to another embodiment of the invention, is shown in insert b) of FIG. 8. One of the main differences between said embodiment and the preceding embodiments is that the wall 120 forms, on the side of the internal volume V110, protrusions similar to the protrusions 502 of the embodiment illustrated in FIG. 4 a), i.e. protrusions arranged opposite each spacer 140, so as to raise the fuse link 130 with respect to the rest of the wall 120.

As in the previous embodiment, the spacer 140 comprises herein the central layer 844 formed of a polymer film, which is attached to the wall 120 by matching the contour of the wall 120. More particularly, the central layer 844, bonded to the wall 120 by means of the connecting layer 852, matches the profile of each of the protrusions 502. The fuse link 130 is thereby electrically separated from the wall 120 in a simple and economical manner.

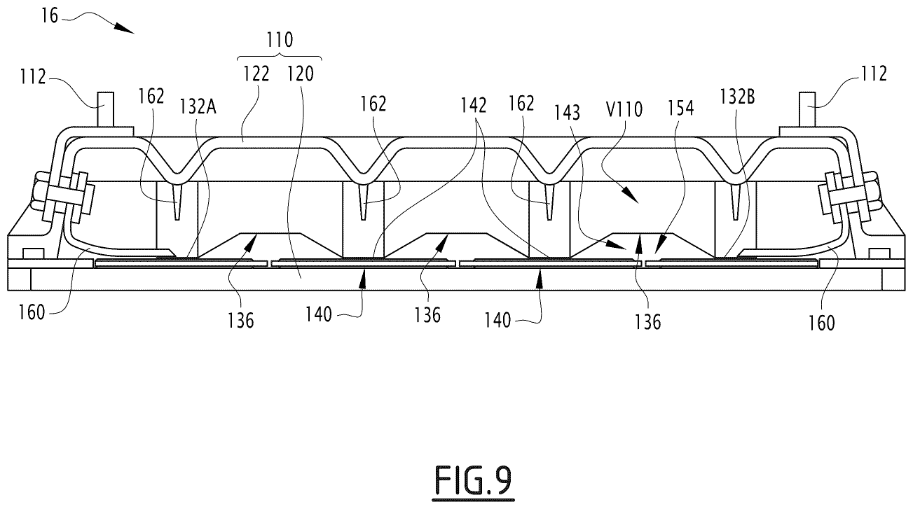

A fuse 16, according to another embodiment of the invention, is shown in FIG. 9. One of the main differences between said embodiment and the preceding embodiments is that the terminals 112 are connected to the ends 132A and 132B of the fuse link by flexible conductors 160. On the other hand, the supplementary portion 122 is herein made in one part, and comprises, on the side of the internal volume V110, protuberances 162. Each of the protuberances 162, which are herein seen in sections, has a flattened shape and extends along a transverse plane, i.e. a plane orthogonal to the longitudinal axis X100, from the rest of the supplementary portion 122 toward the opposite fuse link 130. The protuberances 162 are thereby arranged opposite the fuse link 130, on the same side of the fuse link 130. The protuberances 162 are arranged on both sides of each reduced section 136 so as to limit the propagation of the electric arcs in the internal volume when one of the reduced portions melts. In the example illustrated, a protuberance 162 is provided opposite each of the intermediate supports 142 and opposite each of the end supports 132A and 132B.

In a variant, when the fuse link 130 comprises a plurality of reduced sections 136, two protuberances 162 are arranged on both sides of at least one of the reduced sections.

In the embodiments described, the wall 120 is made of a thermally conductive material, so as to remove the heat generated when an electric current flows through the fuse link. In the examples, the wall 120 is made of a metal wafer, more particularly copper, which has a good compromise between thermal conductivity and cost, while being resistant to impacts. The wall 120 being herein electrically conductive, the central layer 144 of the spacers 140 consequently comprises two opposite faces electrically insulated from each other. In the examples described, the spacer 140 comprises either a ceramic wafer 148 or 448, or a polymer film 744 or 844.

In a variant (not shown), the wall is made of a thermally conductive but electrically insulating material. As non-limiting examples, the wall is made of thermally conductive resin, e.g. epoxy resin (with a thermal conductivity λ of the order of 1.5 W/m·K), or else hot-injectable resin, in particular on base of polyamide 6—denoted by PA6—or polyphenylene sulfide—denoted by PPS—or polycarbonate—denoted by PC—.

In the example illustrated, the fuse link 130 is made in one piece, the end supports 132A, 132B, and the intermediate supports 142, 942, . . . , 1342, each being attached to the wall 120 by means of a respective spacer 140.

In a variant (not shown), the fuse link is made of a plurality of pieces. For example, each piece comprises a single reduced section, interposed between two end supports, each of the end supports being attached to the wall 120 by means of a spacer 140, so as to keep the corresponding reduced section at a distance from the wall. Although serving to implement the advantages of the invention, such configuration is however not preferred because the assembly of each piece of fuse link to the wall 120 is delicate and takes time. In the embodiments shown, the fuse link 130 comprises a plurality of reduced sections 136, an intermediate support 142 being provided between each reduced section 136. Such layout is not limiting.

In a variant (not shown), the fuse link 130 comprises two consecutive reduced sections 136 without an intermediate support arranged between the two reduced sections. According to another variant, the fuse link 130 comprises two intermediate supports, or even more, inserted between two consecutive reduced sections, like the fuse link of FIG. 6 b).

More generally, whether the fuse link 130 comprises one or a plurality of main portions 134, each with at least one reduced section 136, at least one of the main portions 134 comprises at least one support, whether an end support 132A, 132B, or an intermediate support 142, 942; . . . ; 1342, by which the main portion 134 is attached to the wall 120, the support being arranged so as to hold the or one of the reduced sections 136 at a distance from the wall 120. Preferably, the support or supports are arranged to keep each reduced section 136 of the main portion 134 in question at a distance from the wall 120. The fuse comprises at least one spacer 140, each spacer being inserted between each support and the wall 120. Depending on the case, each support is associated with a respective spacer 140. In other words, each spacer 140 is associated with only one support. Alternatively, the same spacer 140 is inserted between the wall 120 and a plurality of adjacent supports.

When the or one of the main portions 134 comprises two reduced sections 136, an intermediate support 142; 942; . . . ; 1342 is advantageously provided between the two reduced sections, so as to keep the two reduced sections 136 associated with the intermediate support at a distance from the wall 120.

Multiple configurations are possible, and a person skilled in the art will be able to find the best compromise between rigidity of the fuse link and bulk depending on the adjustment requirements.

The aforementioned embodiments and variants can be combined with each other so as to generate new embodiments of the invention.

1. A fuse comprising:
a housing comprising a wall made of metal and defining an internal volume of the housing, the wall being cooled from the outside of the housing;
a fuse link comprising:
a main portion comprised of one piece, which is received in the internal volume and which comprises:
two opposite ends;
a reduced section between said two ends; and
at least one support by which the main portion is attached to said wall, each support being arranged so as to maintain said reduced section at a distance from said wall; and
at least one spacer, inserted respectively between said at least one support and said wall, each spacer comprising:
a central layer comprising two opposite faces electrically insulated from each other; and
two connecting layers, each of which comprises a connecting material, and which are applied to a respective side of said central layer, one of the connecting layers being attached to said wall, while the other connecting layer is attached to each said support.

2. The fuse according to claim 1, wherein:
said main portion comprises two reduced sections,
said main portion comprises an intermediate support, which is arranged between said two reduced sections and which is attached to said wall by means of one of said at least one spacer, and
said fuse link is formed so as to maintain said reduced sections associated with said intermediate support at a distance from said wall.

3. The fuse according to any of claim 1, wherein
said at least one support is located outside the conduction path of said fuse link when a current flows through said fuse link.

4. The fuse according to claim 3, wherein
said at least one support comprises at least one support lug, each support lug being formed by cutting out said fuse link and having an elongate shape with a first end, which is connected to said fuse link, and a second end, which is opposite the first end and which is attached to said wall by the corresponding spacer.

5. The fuse according to claim 4, wherein, for at least one of said at least one support lug, that support lug is cut in the vicinity of said reduced section, the cut in the support lug forming a perforation associated with said reduced section.

6. The fuse according to claim 3, wherein
each of said at least one support is formed by folding a folding zone of said main portion, the folding zone extending along a length of said main portion and comprising two end zones and an intermediate zone located between said two end zones, and
said intermediate region is folded to form the support, while said two end regions are in electrical contact with each other.

7. The fuse according to claim 1, wherein,
said main portion comprises two supports, associated with said reduced section,
an insulating element is inserted between said reduced section and said wall, and
the insulating element at least partially closes a gap between said two supports associated with said reduced section.

8. The fuse according to claim 1, wherein
said main portion comprises two neighboring supports associated with said reduced section, and
for the two spacers associated with said two neighboring supports, the central layer of the two spacers is made in one piece, so as to close off a gap between said two neighboring supports.

9. The fuse claim 1, wherein said central layer comprises an electrically insulating polymer material.

10. The fuse claim 1, wherein said central layer comprises a wafer made of ceramic.

11. The fuse according to claim 1, wherein studs are inserted between each of said at least one spacer and said fuse link so as to increase a distance between said reduced section and said wall.

12. The fuse according to claim 1, wherein said wall comprises protrusions formed on the surface of said wall and provided opposite each said spacer so as to increase a distance between said reduced section and said wall.

13. The fuse according to claim 1, wherein
said housing comprises, in addition to said wall, a supplementary portion of said wall,
said supplementary portion comprises an insulating material and delimits, with said wall, the internal volume of said housing, and
said supplementary portion comprises at least two protuberances, so as to limit propagation of electric arcs in the internal volume when said reduced section melts.
